(19) United States
(12) Patent Application Publication
(10) Pub. No.: US 2010/0235401 A1
(43) Pub. Date: Sep. 16, 2010

(54) Progress and performance management method and system

(76) Inventor: Steven Francisco, Bronx, NY (US)

Correspondence Address: Andrew A. Anissi, Esq., 86 Argyle Road, Brooklyn, NY, 11218, US

(21) Appl. No.: 12/381,041

(22) Filed: Mar. 6, 2009

Related U.S. Application Data
(63) Continuation-in-part of application No. 11/644,550, filed on Dec. 21, 2006, now abandoned.

(51) Int. Cl. G06F 17/30

(52) U.S. Cl. 707/802; 707/E17.044

(57) ABSTRACT

Tracking progress and performance data of subjects by building rubrics of data entry fields to be tracked, assigning a machine readable tag to each data field, observing subjects, forming opinions based on such observations, using a tag reading device to read data field tags corresponding to observations and opinions, transmitting tag data to a database, and comparing such data between subjects and over time.

### RELATED APPLICATION

This application is a continuation-in-part of, and claims the benefit of priority from, U.S. patent application Ser. No. 11/644,550, filed on Dec. 21, 2006, the entirety of which is incorporated herein by reference.

### FIELD OF THE INVENTION

The present invention is directed to a performance tracking system and method. In particular the present invention is directed to a performance tracking system and method using tags and a tag reading.

### BACKGROUND OF THE INVENTION

The present invention relates to a method and system for collecting data to track performance.

Some embodiments of the method and system of the present invention collect objective and subjective data to track performance of students

Other embodiments of the method and system of the present invention collect data in other contexts, to track performance.

A number of performance tracking systems and instruction systems are known in the art.

U.S. Patent Application Publication Number 2005/0069853 to Tyson, et al. describes performance tracking systems and methods. One embodiment describes receiving standardized physical performance test data over a network from a test site, which standardized physical performance test data over a network from a test site, which standardized physical performance test data corresponds to physical performance for a plurality of individuals, and processing the standardized physical performance test data to provide standardized data of physical performance among the plurality of individuals.

U.S. Patent Application Publication Number 2003/0232319 to Grisham, et al. discloses a network-based method and system for sensory/perceptual skills assessment and training. The system includes an assessment module or system, training modules, a centralized database for storing assessment, training and other data, and a feedback mechanism for parents, teachers and doctors that allows immediate input regarding either a particular person's data or a group analysis.

U.S. Pat. No. 6,606,479 to Cook, et al. discloses an agent based instruction system and method. Disclosed are one or more service systems with sufficiently large data capacity discs for storing all school-student data, all instructional materials, and all software used in the system. Optionally, the service can use more student data objects in an object-oriented database. The method is used to distribute software, instructional materials, and school-student data from these servers. In alternative embodiments there can be more than one server with software and data component storage divided as convenient across the servers. In further embodiments, the server can be a central host system. Access to the school-student data allows teachers and administrators to track student performance by class, grade, subject, school, etc.

U.S. Patent Application Publication No. 2003/0134261 to Jennen, et al. discloses a system and method for assessing student achievement levels for purposes of identifying students at risk for not meeting minimum academic standards as measured using standardized tests, and for tracking or monitoring student academic performance levels. The system and method comprise producing a pool of curriculum-independent general outcome measures (GOMs) of substantially equal difficulty for a particular grade level, and further comprises a system and method of assessing and monitoring students in that grade level using the pool of GOMs for the purpose of identifying those students at risk for not meeting minimum standardized test target scores and for tracking or monitoring student academic performance levels. The system comprises a database accessible remotely by authorized users through a network and user interface in which authorized users can remotely input student academic performance information and selectively retrieve that information for display through the user interface.

U.S. Patent Application Publication No. 2006/0172274 to Nolasco discloses a system and method for real time tracking of student performance based on state educational standards. This tracking system platform provides the ability to access al of the stored data and control modules of the tracking system. This includes state educational standards, lesson plans, the assignments, the student grade data, student demographics data and behavior and attendance data. In addition to providing the ability to access and manipulate all of this data, the tracking system platform provides web based graphical user interfaces and provides the ability to externally access the state educational standards website via the internet. The tracking system platform controls all aspects of module registration application structure, security and permissions.

U.S. Patent Publication No. 2005/0053908 to Satheesh, et al. discloses an education management system, method and computer program. The system enables monitoring of students' progress, provides automated or manually generated feedback, compares scores of different students in a class or across classes, assesses the quality of questions and compares performance of various classes, using the control software and the data stored in the main database.

U.S. Patent Application Publication No. 2004/0215587 to Bertrand, et al. discloses a goal based education system with support for dynamic characteristic tuning. According to this system, while a student is performing the work in various tasks, every action taken, the feedback the student receives and any other indicators are tracked in the student tracking database. Periodically, all or part of the tracked data are transmitted to a central location. The data can be used to verify the student completed all of the work and can be further analyzed to measure his degree of mastery of the content.

U.S. Pat. No. 6,704,541 to Ciarallo, et al. discloses a method and system for tracking the progress of students in a class. The system includes a computer network having a school computing system and one or more student computers connected with the school computing system by a communication link. The school computing system includes one or more databases adapted to store data relating to the performance of course activities by one or more students in the course. The school computing system also includes a course graphic generator adapted to generate one or more course graphics representative of the course and a progress graphic generator that can generate one or more progress graphics representative of the progress of the one or more students in the course.

U.S. Patent Application Publication Number 2004/0110119 to Riconda, et al. discloses a web-based knowledge management system and method for education systems. Riconda discloses what they call the eSD System which they disclose to be a robust data schema and database engine that stores and tracks virtually every data element about a student and stored in a student record, according to a data content template customized at the school district level, and generates an output that is presented in a logical, meaningful manner. This system enables member users to add data for inclusion in the student portfolio database.

U.S. Patent Application Number 2004/0033475 to Mizuma, et al. discloses a method and system for monitoring and managing the educational progress of students. The Mizuma system relates generally to educational systems and can include methods of using a computer system to create student records in a database, methods of using a computer system to present student records stored a computer database, methods for measuring a student's performance relative to predetermined educational goals, automated processes that utilize a relational database for student education, automated educations systems, and computer programs for automating an education system.

Although various methods and systems exist in the prior art, none of the references, individually or in combination, disclose the present invention as claimed.

Most current applications of data in education are summative and, as such, lack the ability to correct problems and patterns as they arise. Similarly, through the use of summative testing, these solutions create a level of stress in the students that can mire performance and lead to discipline and motivation problems. Furthermore, such testing gives teachers an incentive to “teach to the test” and not to deepen though processes. As a result, higher order thinking, in aggregate, is suppressed and discouraged.

### SUMMARY OF THE INVENTION

To address this situation, the present invention takes a different approach to data collection. While not completely replacing objective data, the present invention also relies upon multiple subjective measures over time. As these measures are the hallmark of effective teaching, teachers already participate in these processes daily in the form of conferences, anecdotals, and observations. However, these volumes of data are undervalued in traditional instructional management solutions. The present invention places the teacher's professional assessment at the forefront of their decision making. The inventive system and method also make the entry of and access to this subjective data extremely simple so that teachers can easily utilized the data and implement appropriate procedures in their classrooms.

It should be noted that examples of the present invention are described herein in the context of teaching, but that the system and method described may be used in various other contexts for tracking performance data. For example, tracking employee performance is one other category of performance data that can be tracked according to the described system and method.

Accordingly, it is an object of the present invention to provide a method and system for recording and tracking various types of objective and subjective data relative to customizable subjects and topics geared toward various categories of individuals, groups, or other entities.

One embodiment of the present invention achieves this object, in the context of tracking students' performance data, by providing a system for collecting objective and subjective data, which system includes a software that generates machine readable tags (e.g. barcodes), a computer system, a tag reading device (e.g. a barcode scanner), subjects to track (e.g. students), a user (e.g. a teacher) to observe the subjects and use the tag reading device to read the machine readable tags, and a database for storing the input. In addition to conventional objective data such as test scores, attendance, etc., the system allows subjective data categories to be customized, and later to be tracked and entered.

One embodiment of the present invention achieves the above object, in the context of tracking students' performance data, by a method substantially as follows. Data topics (e.g. grades, attendance, degree of class participation, etc.) are inputted into a software. Scales of data associated with each topic are inputted into the software. For example, such a scale could be a one to ten scale, or a simple yes or no, or even a text entry. The specifics of the scale are customizable. Data referencing subjects (e.g. student names) is inputted into the software. The software generates bar codes associated with the inputted data topics and the inputted subjects. A user (e.g. a teacher) prints the bar codes and their associated data categories onto a material (e.g. paper). The user observes a subject (e.g. a student). With respect to objective data categories being tracked, if any, the user uses a barcode scanner to scan a barcode associated with a subject's name, and then scans a barcode associated with the data. With respect to subjective data categories being tracked, if any, the user forms an opinion on the subject being tracked, then uses a barcode scanner to scan a barcode associated with a subject's name, and then scans a barcode associated with the data. The user may a plurality of subjects and track data in this way. The data inputted into the barcode scanner is later transmitted to a computer system with the software, which can then output the data as needed.

As demonstrated by the above embodiment, by providing machine readable tags, such as bar codes, which directly access specific data entry fields, it is not necessary to move through other fields or menus as is necessary with a number of prior art systems that utilize a computer screen and keyboard as the input mechanism.

Although at present bar codes are technologically easy to implement, other embodiments of the method and system may use radio frequency identification (RFID) tags in place of bar codes. If an RFID tag is used, then the bar code scanner would be replaced with an appropriate reader for the RFID tag. A system or method using a digital pen or a touch screen interface can also be used.

Other features and advantages of the present invention will become apparent from the following description of the invention that refers to the accompanying drawings.

### BRIEF DESCRIPTION OF THE DRAWINGS

FIG. 1 is a flowchart showing method steps in accordance with certain embodiments of the present invention.

FIG. 2 is a schematic showing aspects of system for tracking performance in accordance with certain embodiments of the present invention.

FIG. 3 is a flowchart certain specific method steps in accordance with an embodiment of the present invention.

FIG. 4 is an example of a single scan mode tracking sheet with bar codes as the machine readable tags.

FIG. 5 is an example of a tracking sheet to be used for multiple mode tracking, with bar codes as the machine readable tags.

FIG. 6 is an example of a tracking sheet to be used for multiple mode tracking, with bar codes as the machine readable tags. FIG. 6 also provides an example a rubric for organizing data fields.

FIG. 7 is an example of data fields designated for tracking, using a software.

FIG. 8 is an example of scales being designated for tracking, using a software.

FIG. 9 is a flowchart showing steps of the method for tracking subjective performance data in accordance with an embodiment of the present invention.

### DETAILED DESCRIPTION OF THE PREFERRED EMBODIMENT

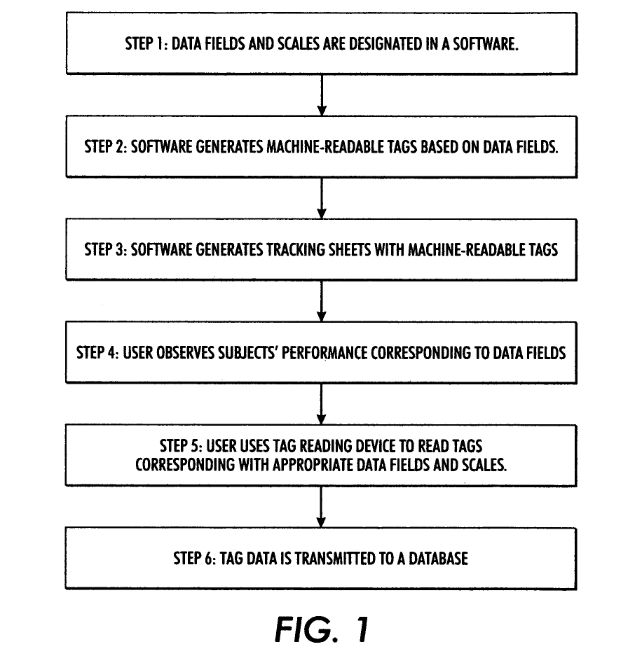

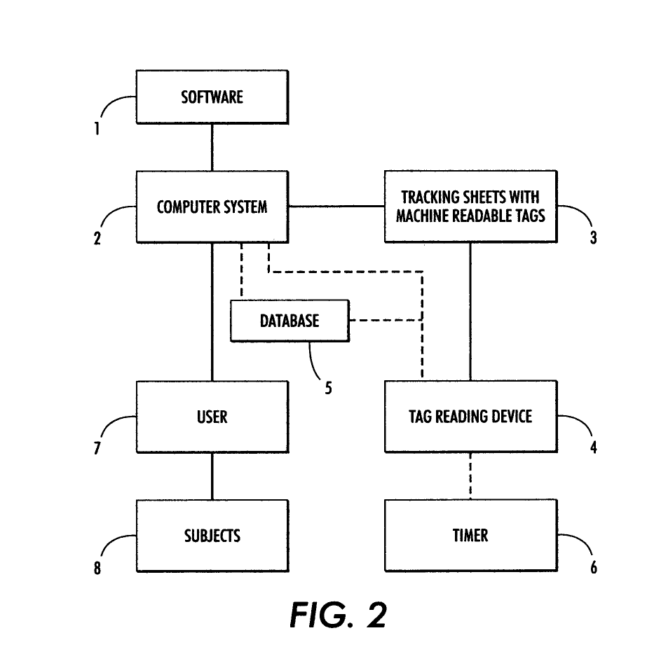

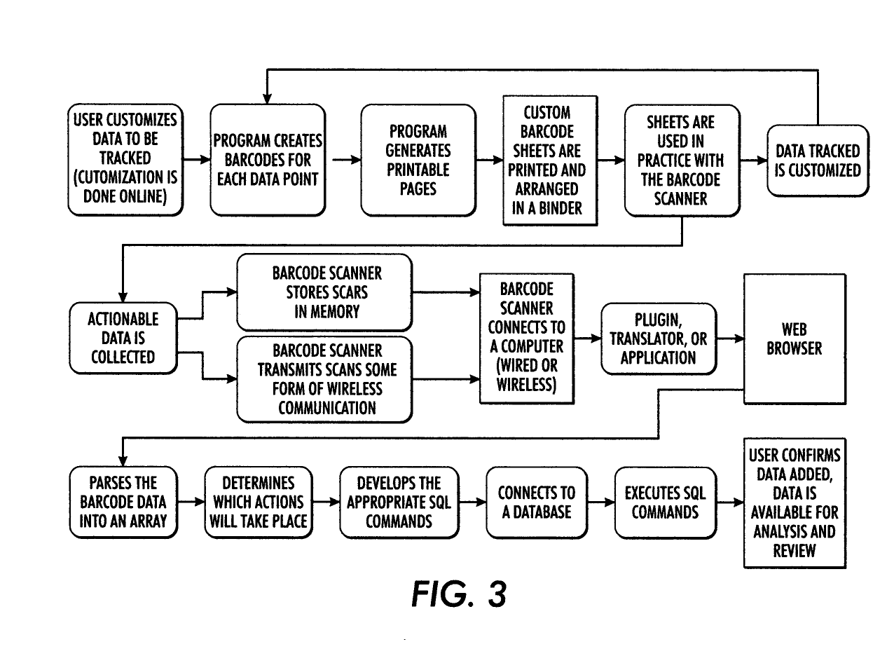

Referring now to the drawings wherein like references characters represent like and corresponding parts throughout the several view, there is illustrated in FIG. 1 and FIG. 9 method steps of certain embodiments of the present invention. Illustrated in FIG. 2 is a schematic showing system embodiments of the present invention.

FIG. 2 includes a software 1 on a computer system 2. The software 1 is a software used to control certain aspects of the system, particularly to track data fields, scales, and typically to store and process data generated by the system, to be disseminated by the user or others. The software may reside on the computer system 2, or else be remote, e.g. web-based.

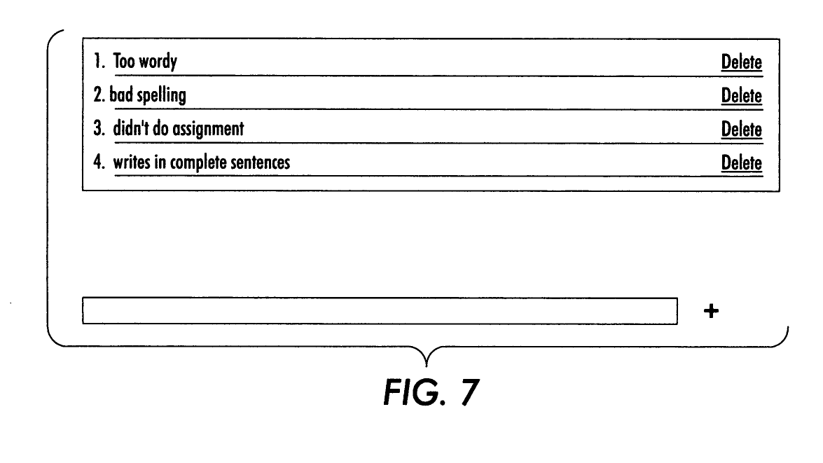

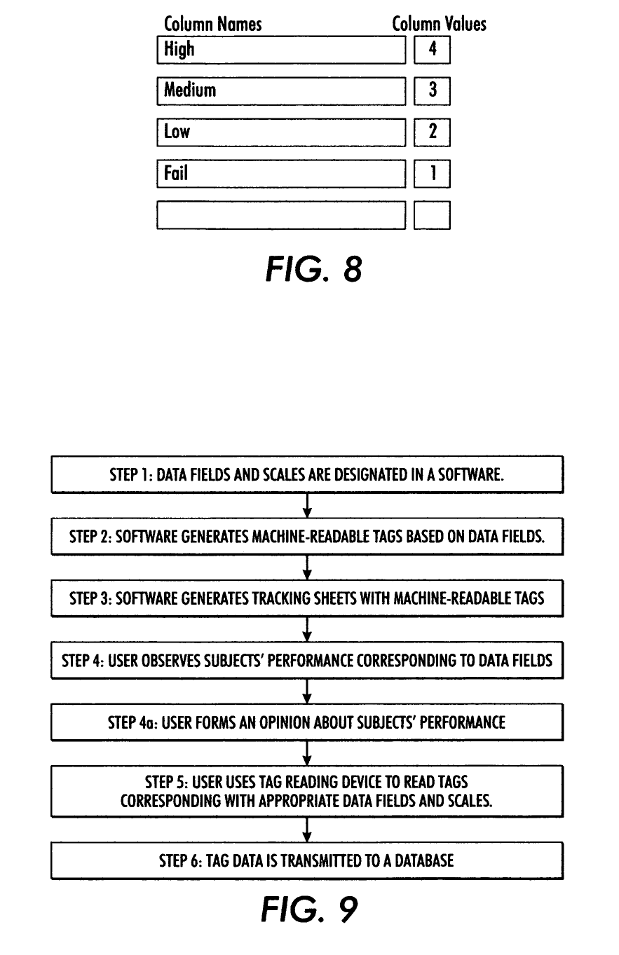

Information is entered into the software 1 designating data fields relating to subjects, categories of data to be tracked, and scales. The data fields may be designated by the user 7 or else by another person, prior to a use of the system in conjunction with such designated data fields and scales. In the context of classroom teaching, the teacher is the user 7 and the students are the subjects 8. The teacher may decide to use the system to track certain performance data on such teacher's students, such as how well the students are progressing with their writing skills. The teacher could, for example, designate data fields such as “too wordy” or “bad spelling” to track, when noticed in the classroom for particular students. FIG. 7 showing these phrases listed as data fields entered into the software, to be tracked. The user 7 could also designate scales, to rate the data fields. FIG. 8 shows a four point scale, where, with respect to a data field, a user 7 could select high, medium, low, or fail as a rating.

However, the user does not need to be the one to designate the data fields and scales. Data fields and scales could be designated by someone else before the user uses the system. In the context of teaching, for example, department heads of the school, or even the State's education department might be the ones designating what data fields and scales should be tracked. However, to make the best use of the system, the user can designate data fields and scales. Since the user 7 is the one who will be observing the subjects, the user 7 is in a unique position to understand the subjects and collect subjective, in addition to objective, data. The user 7 can change the data fields and scales according to data collected. Additionally, the user 7 can make, recommend, inspire, emphasize, or order behavior changes directly to the subjects based on the data collected. In the context of teaching, a teacher could change his curriculum based on data collected from the students. Likewise, the teacher, while observing the students, may notice particular aspects to the students' performance and progress that the teacher wishes to track. That being the case, the teacher can use the computer system and software to change or add data fields and scales to be tracked 7

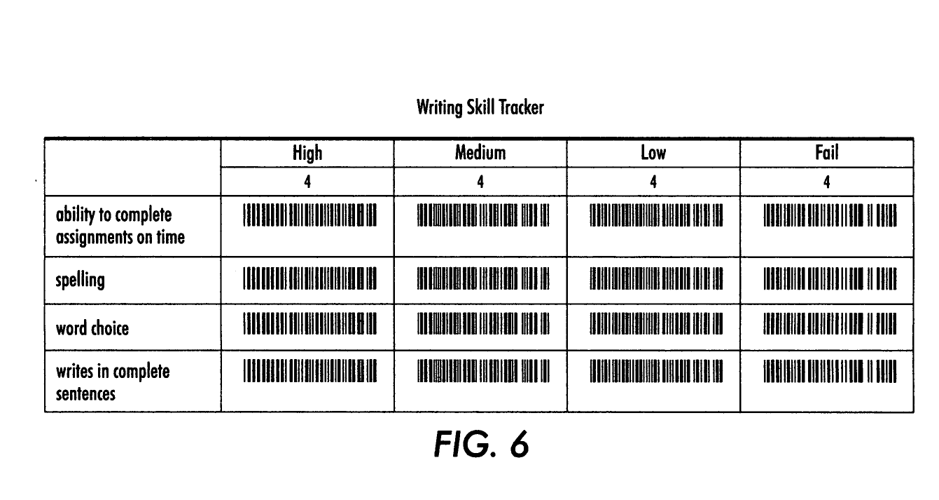

FIG. 6 shows an example of a tracking sheet 3 with a rubric of data fields and scales to track the performance of students' writing skills. FIG. 6 uses bar codes as the machine readable tags on a tracking sheet 3, which can be scanned with a bar code scanner as the tag reading device 4, to record a certain scale for a particular data field, based on an observation by a user 7.

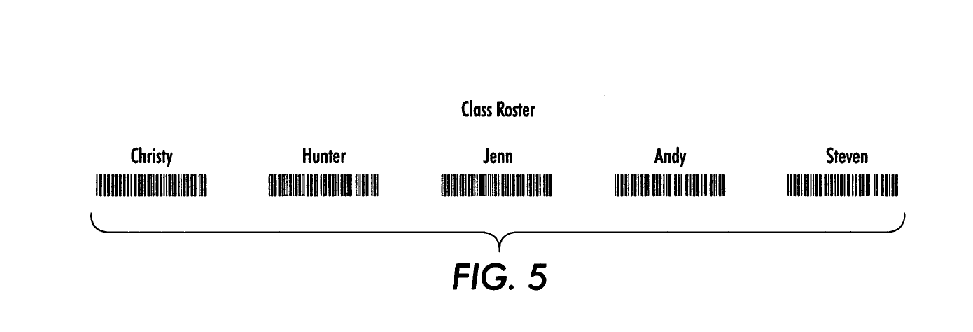

An embodiment of the method and system could operate as follows. The user 7 is a teacher teaching a writing class for kids. The teacher uses the computer system 2 and software 1 to designate data fields and a scale. The teacher designates the data fields of FIG. 6, i.e. “ability to complete assignments on time,” “spelling,” “word choice,” and “writes in complete sentences.” The subjects 8 are the students of the class. The teacher also designates student names as further data fields, as in FIG. 5, showing “Christy,” “Hunter,” “Jenn,” “Andy,” and “Steven.” The teacher also designates the scale shown on FIG. 8 and FIG. 6, with the variables “4 High,” “3 Medium,” “2 Low,” and “1 Fail.” The teacher uses the computer system to generate tracking sheets with barcodes 3, the barcodes being the machine readable tags. The tracking sheets 3 are generated in the form of paper printouts of FIG. 5 and FIG. 6, which the teacher brings to class with him. The teacher also brings a bar code scanner to class, the bar code scanner being the appropriate tag reading device 4 to read the bar codes on the tracking sheets that were generated. In this example, the teacher uses a two scan mode for tracking progress and performance. To that end, to record an observation of a data field, the teacher scans a student name from the FIG. 5 and then scans a bar code from FIG. 6 according to the appropriate data field and scale. During a class, the teacher notices Christy, a student, consistently exhibits a high skill at word choice in her writing, which are read aloud during class time. Rather than having to write in a notebook or type up notes, the teacher simply scans the bar code for “Christy” on the FIG. 5 tracking sheet 3, and then scans the bar code for “word choice” and “4 High” on the FIG. 6 tracking sheet. The scanned data is stored in an organized and recallable form on the bar code scanner's 4 internal memory, the internal memory serving as a database 5. A timer 6 on the bar code scanner also records the time of the scan. At the end of class, the teacher connects the bar code scanner 4 to the computer system 2 and uploads the scanned tag and time data to the computer system 2, which has its own database via a hard disk and the software 1. Whether the scanned data is transferred from one database to another is irrelevant, so long as it is ultimately in a database readable by the software 1. In another embodiment, the tag reading device 4 is attached directly to an external hard drive, which stores the data in a database. In another embodiment, the tag reading device 4 is attached to a laptop, which serves as the computer system 2. The teacher later reviews and compares the tag data in the database 5 using the software 1, with related tag data from different times and/or different subjects.

In another embodiment, the tag reading device 4 is attached to a mobile computing device, which serves as the computer system 2.

In preferred embodiments, the tag reading device 4 is connected to, or has internally, a timer 6, which records the time that a particular reading of a machine readable tag is taken, and includes the timing data with the tag data. This is helpful for plotting progress and performance over time, a crucial aspect of the present invention, by providing the user the ability to compare a reading taken at each point in time with readings taken at other points in time. The timer 7 aids in the use of the method and system for real-time tracking of performance and progress, allowing more informed management of the subjects being tracked.

The data collected by the method and system already provide for a user being able to compare subjects to one another in terms of comparing scale levels for particular data fields.

The tag reading device 4 does not necessarily have to be a bar code scanner. The tag reading device 4 and machine readable tags on the tracking pages 3 could be something functionally equivalent for the data collection purposes of the method and system. For example, the machine readable tags on the tracking pages 3 could be RFIDs, and the tag reading device 4 could be an RFID reader.

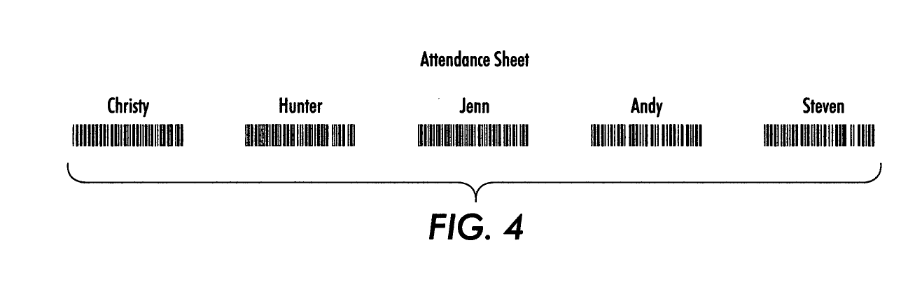

The designation of data fields and tracking sheets 3 can take various forms depending on the data fields to be tracked. For example, the method and system can use a one scan mode, in which the user 7 has a tracking sheet 3 encoded with data fields tracking specific data about one subject 8, as in FIG. 4. There is no need to read the subject's tag from a roster sheet like FIG. 5 because the subject's ID is encoded into the tag itself. This is particularly useful for Boolean observations, where a user is tracking how often an event occurs and the data is being tracked for particular subjects. In this mode, each individual reading of a tag represents an entry of tag data for the corresponding observation. Because each tag reading represents an entire entry, tracking sheets for single mode scan may be of one subject with many assessments, or else the tracking sheets may be of multiple subjects for a single assessment, such as in FIG. 4 where the single assessment is attendance. Scanning the barcode under “Jenn” on FIG. 4 would create a data entry indicating that Jenn attended, with the timer automatically adding data on the day in which Jenn was in attendance.

The method and system can also use multiple scan modes, such as a two scan mode. In the two scan mode, a single data entry includes data from two separate readings of a tag. The most common example of a two scan mode would be a first scan of a roster sheet (as in FIG. 5) to record data identifying a subject, following by a scan of a rubric comprising an observation being tracked and the scale of performance. FIG. 6 shows an example of a tracking sheet with such a rubric, wherein each row indicates an observation being tracked and each column indicates a level of performance. In this example, if a teacher using a barcode scanner first scans “Hunter” on the roster sheet (FIG. 5) and then scans the medium spelling barcode on the rubric sheet (FIG. 6), the data entry generated includes the information that the teach observed Hunter exhibiting a medium level of spelling skill. If a timer 6 is incorporated in the method and system, the data entry field will also reflect the time in which the observation was taken, which allows comparisons to be made to other observations of Hunter's spelling skill on different days, in order to track progress of performance.

Similarly, data fields may be designated in the method and system to allow a three scan mode or higher.

Certain embodiments of the method and system use rubrics for designated data fields and as a way to organize data on a tracking sheet. Rubrics are two dimensional tables with column and row categories acting as variables. The combinations of such columns and rows are the data fields in the tables. See, for example, FIG. 6. Rubrics help to structure and present tags based on customized data fields. Rubrics may have virtually any number of columns or rows. Performance levels and observations can be used as columns or rows interchangeably. Where there is only a single performance level being tracked, or only a single type of observation being tracked, the rubric will resemble a list.

Ideally, a user will use the method and system to evaluate the user's own management of the subjects, in order to focus on improving targeting areas of performance based on observations of the subjects' progress over time. In the context of teaching, a teacher using the method and system can change his curriculum for the same set of students based on observations of what areas students have trouble with and what areas are lagging in progress.

In education, the system can treat observations as teaching goals, designate the observations and performance scales as data fields, and align them with district or state standards. Or else a teacher can use the method and system based on the teacher's own teaching goals, and designate data fields to educate himself on the students' performance and progress, in order to alter his teaching approach or curriculum to better customize his teaching to the needs of the students.

An embodiment of the progress and performance management method operates as set forth on FIG. 1. In Step 1, data fields and scales are designated in a software. This can be done by the user or by another, as describes above. In Step 2, the software generates machine-readable tags based on the data fields. In Step 3, the software generates tracking sheets with the machine-readable tags. In Step 4, user observes subjects' performance corresponding to data fields. In Step 5, the user uses a tag reading device to read tags corresponding with appropriate data fields and scales. In Step 6, the tag data is transmitted to a database. The transmission of data is achieved either through a wire, a cable, another type of signal connecting medium, or through a wireless connection.

The system and method inherently contains a user, and a benefit of the system and method is the potential to collect subjective data in addition to objective data. While a machine could be programmed to read and interpret an objective event, a user, being a conscious human, not only observes, but also interprets the observation through a consciousness and forms an opinion regarding such observation, particularly with respect to abstract data types. While the system and method can track objective data, such as whether a student in a classroom answers a multiple choice question correctly, the system and method can also track subjective data, as designated by data fields. For example, a teacher could designate data fields regarding whether a student is happy or whether a student's poem is provocative, and then record such data after observations of students and the forming of opinions.

Though examples of the method and system herein are generally presented in the context of teaching, other applications of the method and system will occur to those skilled in the art. For example, certain embodiments of the method and system are used by managers to track and manage progress and performance of employees. Certain other embodiments of the method and system are used by an inspector or manager to conduct inspections of the conditions of a site, to collect real-time data to be used for more informed management of the site's conditions. Certain other embodiments of the method and system are used for interviews, in which observation data can be tracked easily in real time, with an interviewer bringing to the interview tracking sheets 3 with machine-readable tags corresponding to appropriate data fields.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A method of tracking and managing progress and performance data, the method comprising:
designation of data fields;
a software generating a plurality of machine-readable tags based on said data fields;
said software generating a plurality of tracking sheets, said tracking sheets each having one or more of said machine-readable tags;
a user making observations of a plurality of subjects corresponding to said data fields;
said user using a tag reading device to read said machine-readable tags corresponding to said observations; and
transmitting tag data read by said tag reading device to a database.

2. The method of claim 1 wherein,
said data fields include fields corresponding to objective data and fields corresponding to subjective data; and
said step of a user making observations of subjects corresponding to said data fields further comprises the step of said user forming a subjective opinion based on said observations, corresponding to said subjective data fields.

3. The method of claim 1 wherein said tag reading device further comprises a timer, wherein said timer records time data during said step of said user using a tag reading device to read said machine-readable tags, and wherein said recorded time is included with said tag data transmitted to said database.

4. A system for tracking and managing progress and performance data, said system comprising:
a computer system;
a software on said computer system, wherein said software generates tracking sheets with machine-readable tags based on customizable data fields, said data fields corresponding to potential subjects and performance data;
a tag reading device that reads and records tag data from said machine-readable tags;
a user that makes observations of subjects and uses said tag reading device to record data from said machine-readable tags corresponding to said observations; and
a database that receives tag data from said machine-readable tags.

5. The system of claim 4 wherein said tag reading device further comprises a timer that record time data when one of said machine-readable tags is read by said tag reading device.
